(19) United States
(12) Patent Application Publication
(10) Pub. No.: US 2003/0106872 A1
(43) Pub. Date: Jun. 12, 2003

(54) Nipple with air intake valve

(76) Inventor: Hung-Hsiu-Hua Lin, Chang-Hua Hsien (TW)

Correspondence Address: CHRISTIE, PARKER & HALE, LLP, 350 WEST COLORADO BOULEVARD, SUITE 500, PASADENA, CA, 91105, US

(21) Appl. No.: 10/014,051

(22) Filed: Dec. 10, 2001

(51) Int. Cl. A61J 11/02; A61J 9/04

(52) U.S. Cl. 215/11.5

(57) ABSTRACT

A nipple includes a nipple body, a peripheral flange, an air intake tube, and an inlet hole. The flange extends outwardly from a periphery of the nipple body, and has upper and lower flange surfaces. The lower flange surface has a recess which is confined by a side wall and a top wall. The air intake tube projects into the recess from the top wall, and has an end part formed with a split for passage of air. The split divides the end part into two openable valve members. Reinforcement ribs respectively connect the valve members to the side wall, thus strengthening the valve members.

### BACKGROUND OF THE INVENTION

1. Field of the Invention

The invention relates to a nipple, more particularly to a nipple with an air intake valve.

2. Description of the Related Art

Referring to FIGS. 1 and 2, a conventional nipple 1 is shown to comprise a hollow flange 101, a nipple body 102, a hollow air intake tube 105, an inlet hole 108, and a supporting ring 107. The flange 101 and the nipple body 102 cooperate to confine a downwardly opening chamber 103. The hollow air intake tube 105 extends downwardly from a lower surface of the flange 101, and has an end part formed with a split 106. The inlet hole 108 is formed in an upper surface of the flange 101 and is in fluid communication with the air intake tube 105. The supporting ring 107 is disposed on the lower surface of the flange 101, and has a height equal to that of the air intake tube 105 so as to protect the latter from deforming and from being damaged.

It is noted that after the nipple 1 has been in use for a short period of time, the split 106 in the air intake tube 105 loses its resiliency due to fatigue, which can lead to choking of the user. Furthermore, during formation of the nipple 1 by injection molding process, air pressure in the mold accumulates in the end part of the air intake tube 105 such that the end part is easily ruptured. Moreover, cleaning of the nipple 1 is difficult because dirt can accumulate in edges where the supporting ring 107 and the lower flange surface 104 are connected.

### SUMMARY OF THE INVENTION

Therefore, the main object of the present invention is to provide a nipple with an air intake valve having openable reinforced valve members.

Another object of the present invention is to provide a nipple which can be easily cleaned despite the presence of the air intake valve.

According to one aspect of the present invention, a nipple comprises a nipple body, a peripheral flange, a hollow air intake tube, and an inlet hole. The peripheral flange extends outwardly from a periphery of the nipple body, and has an upper flange surface and a lower flange surface. The lower flange surface has a recess which is indented from the lower flange surface and which opens at the lower flange surface. The recess is confined by a side wall which extends upwardly from the lower flange surface, and a top wall which extends transversely of the side wall between the upper and lower flange surfaces. The side wall continuously loops around the recess. The hollow air intake tube projects into the recess from the top wall without extending to a level lower than the lower flange surface, and has an end part formed with a split. The split divides the end part into a plurality of valve members which are openable by moving away from each other for passage of air. The inlet hole is formed in the upper flange surface and is in fluid communication with the air intake tube.

According to another aspect of the present invention, a nipple comprises a nipple body, a peripheral flange, a hollow air intake tube, an inlet hole, and reinforcement ribs. The peripheral flange extends outwardly from a periphery of the nipple body, and has an upper flange surface and a lower flange surface. The hollow air intake tube projects downward from the flange, and has an end part formed with a split. The split divides the end part into two valve members which are movable away from each other for passage of air. The inlet hole is formed in the upper flange surface and is in fluid communication with the air intake tube. The reinforcement ribs are integral with the flange to extend toward and connect respectively to the valve members. Each of the ribs forms an acute angle with a line along which the split extends.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional nipple;

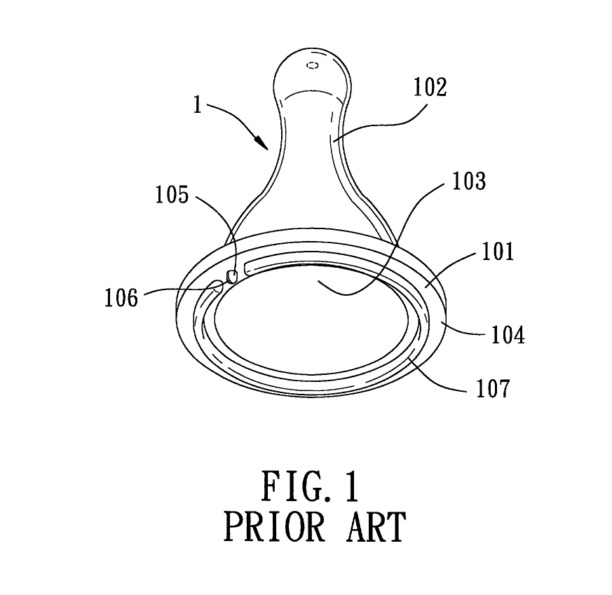

FIG. 2 is a sectional view of the nipple of FIG. 1;

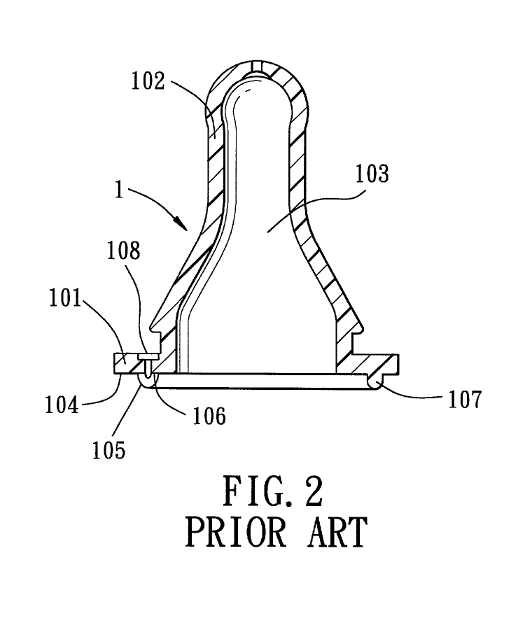

FIG. 3 is a sectional view of the first preferred embodiment of a nipple according to the present invention;

FIG. 4 is an enlarged fragmentary schematic view illustrating an air intake tube of the first preferred embodiment;

FIG. 5 is a partially sectioned view illustrating a bottle incorporating the nipple of FIG. 3;

FIG. 6 is a perspective view of the second preferred embodiment of the nipple according to the present invention;

FIG. 7 is a sectional view of the second preferred embodiment; and

FIG. 8 is an enlarged fragmentary schematic view illustrating how reinforcement ribs are disposed to reinforce valve members of the air intake tube.

### DETAILED DESCRIPTION OF THE PREFERRED EMBODIMENTS

Before the present invention is described in greater detail, it should be noted that like elements are denoted by the same reference numerals throughout the disclosure.

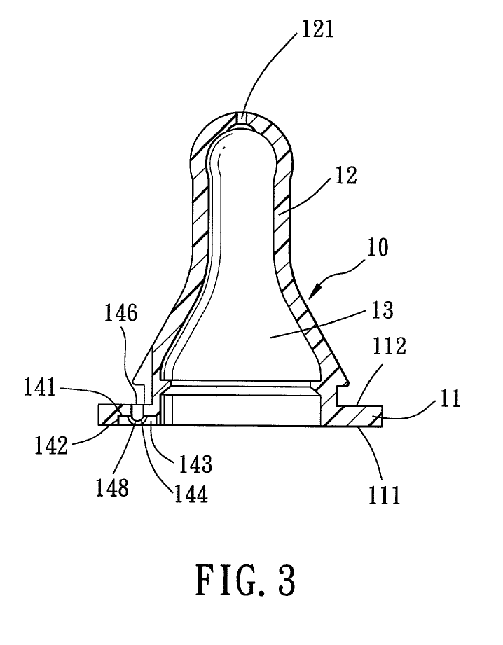

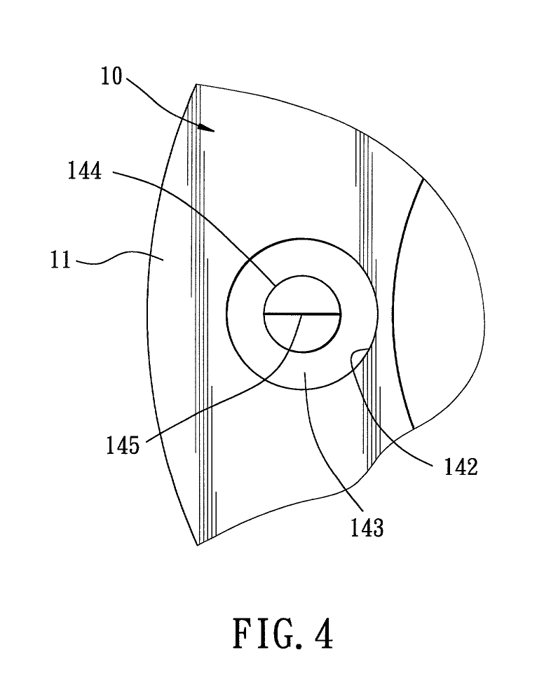

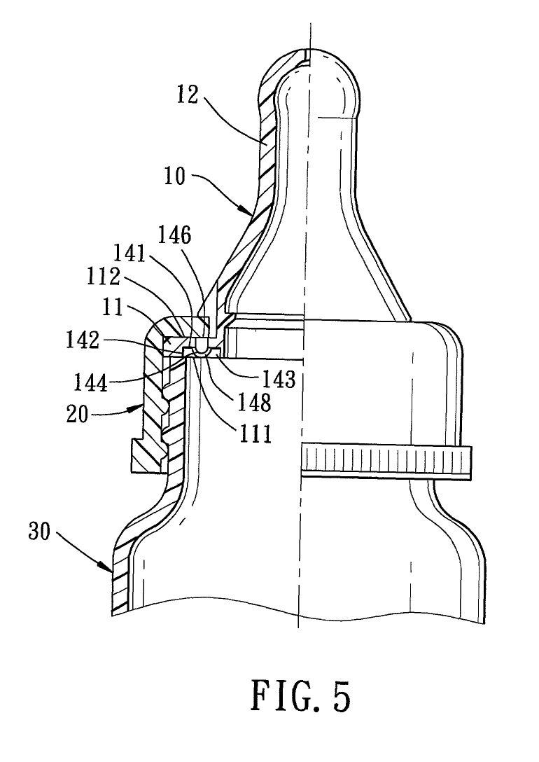

Referring to FIGS. 3 to 5, the first preferred embodiment of a nipple 10 according to the present invention is shown to comprise a nipple body 12, a peripheral flange 11, a hollow air intake tube 144, and an inlet hole 146. The nipple 10 is adapted to be disposed on a bottle 30, and is clamped between a mouth of the bottle 30 and a bottle cap 20. The nipple body 12 and the peripheral flange 11 cooperate to confine a downward receiving chamber 13. The nipple body 12 has a top end formed with a slit 121 that is registered with the receiving chamber 13. The peripheral flange 11 extends outwardly from a periphery of the nipple body 12, and has an upper flange surface 112 and a lower flange surface 111. The lower flange surface 111 is a planar surface which is free of any part projecting downward from the lower flange surface 111, and has a recess 143 which is indented from the lower flange surface 111 and which opens at the lower flange surface 111. The recess 143 is confined by a side wall 142 which extends upwardly from the lower flange surface 111, and a top wall 141 which extends transversely of the side wall 142 between the upper and lower flange surfaces 112, 111. The side wall 142 continuously loops around the recess 143.

The hollow air intake tube 144 projects into the recess 143 from the top wall 141, and has an end part formed with a split 145 and flush with the lower flange surface 111 in this embodiment. The split 145 extends substantially in a diametral direction relative to an axis of the air intake tube 144, and divides the end part into two valve members 148 which are openable by moving away from each other for passage of air.

The inlet hole 146 is formed in the upper flange surface 112 and is in fluid communication with the air intake tube 144.

When sucking, the valve members 148 of the air intake tube 144 are forced apart to let outside air enter the bottle 30 through the inlet hole 146, thereby balancing the pressures inside and outside the bottle 30, and thereby enabling liquid to be drawn smoothly out of the bottle 30 through the slit 121 in the nipple body 12.

When the sucking stops, the valve members 148 of the split 145 are restored back to their closed positions due to the resiliency of the nipple 10. Choking of the user can thus be prevented.

The nipple 10 of the present invention can achieve good air circulation for a long period of time because the air intake tube 144 is concealed in the recess 143. Furthermore, the nipple 10 is easy to clean and material cost can be reduced due to the absence of a supporting ring in the lower flange surface 111 of the peripheral flange 11.

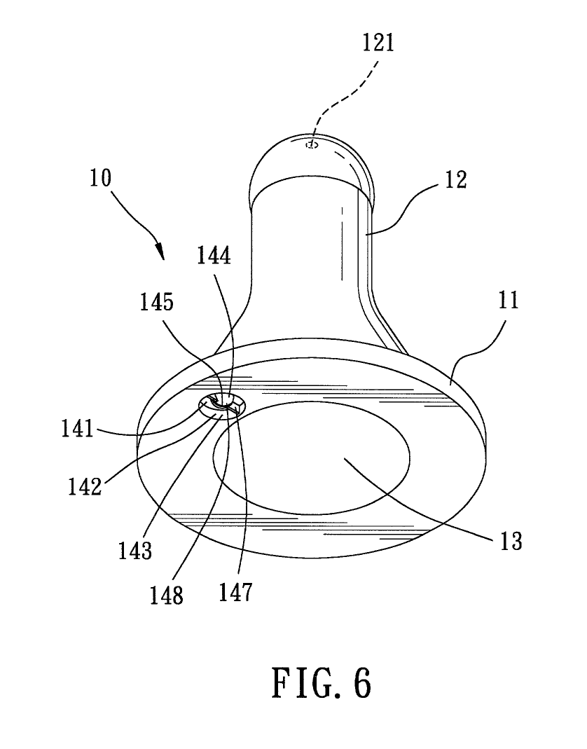

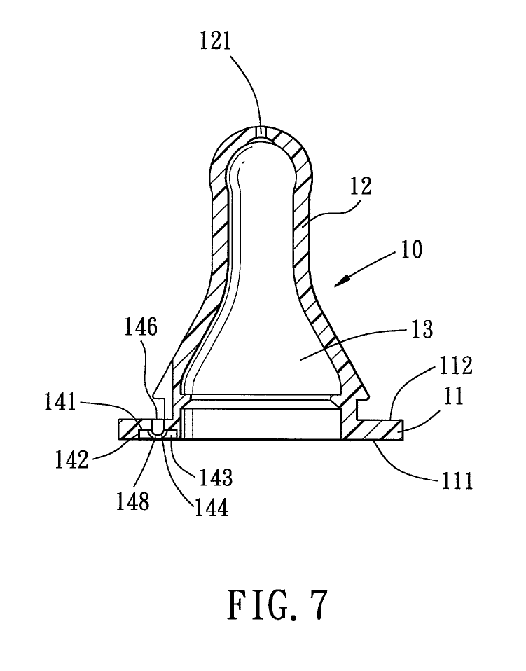

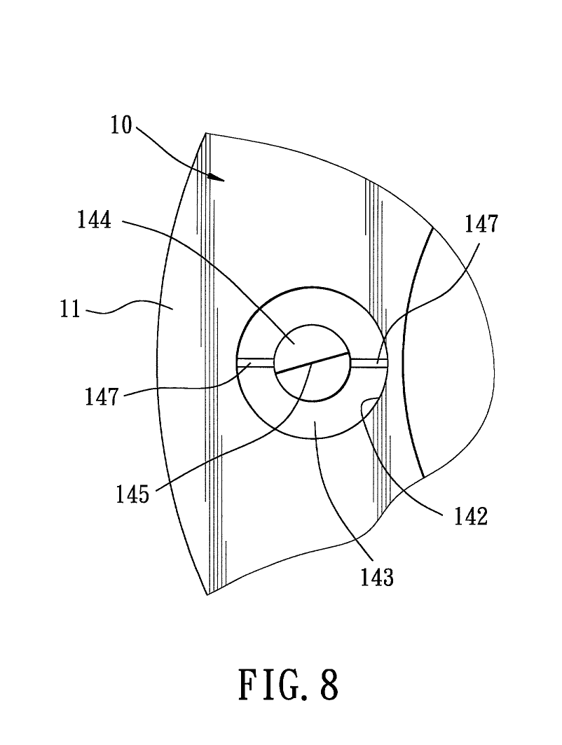

Referring to FIGS. 6 to 8, the second preferred embodiment of the nipple 10 according to the present invention is shown to be substantially similar to the first preferred embodiment, except that the end part of the air intake tube 144 includes two resilient reinforcement ribs 147 respectively connected to the valve members 148 and extending to the side wall 142 for connection with the side wall 142. Each of the reinforcement ribs 147 has a lower end that is flush with the lower flange surface 111 of the peripheral flange 11, and forms an acute angle smaller than 45° relative to a line along which the split 145 extends.

When sucking, the valve members 148 of the air intake tube 144 are forced apart, and the reinforcement ribs 148 are slightly deformed so as to let the outside air enter the bottle. When the sucking stops, the valve members 148 are restored back to their closed positions. Due to the reinforcement ribs 147, the valve members 148 are strengthened to increase resistance against fatigue, and steady flow of the liquid inside the bottle can be maintained. Furthermore, during formation of the nipple 10 by injection molding process, mold cavities for the reinforcement ribs 147 help prevent the air pressure in the mold from accumulating in the end part of the air intake tube 144, thereby increasing the production yield.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A nipple comprising:
a nipple body;
a peripheral flange extending outwardly from a periphery of said nipple body, said flange having an upper flange surface, and a lower flange surface formed with a recess which is indented from said lower flange surface and which opens at said lower flange surface, said recess being confined by a side wall extending upwardly from said lower flange surface, and a top wall extending transversely of said side wall between said upper and lower flange surfaces, said side wall continuously looping around said recess;
a hollow air intake tube projecting into said recess from said top wall without extending to a level lower than said lower flange surface, said air intake tube having an end part formed with a split to divide said end part into a plurality of valve members which are openable by moving away from each other for passage of air; and
an inlet hole formed in said upper flange surface and in fluid communication with said air intake tube.

2. The nipple as claimed in claim 1, wherein said lower flange surface is a planar surface which is free of any part projecting downward from said lower flange surface.

3. The nipple as claimed in claim 1, wherein said end part of said air intake tube further includes reinforcement ribs respectively connected to said valve members and extending to said side wall for connection with said side wall.

4. The nipple as claimed in claim 3, wherein said split extends substantially in a diametral direction relative to an axis of said air intake tube, each of said ribs forming an acute angle with a line along which said split extends.

5. The nipple as claimed in claim 4, wherein said acute angle is smaller than 45°.

6. A nipple comprising:
a nipple body;
a peripheral flange extending outwardly from a periphery of said nipple body, said flange having an upper flange surface and a lower flange surface;
a hollow air intake tube projecting downward from said flange, said air intake tube having an end part formed with a split to divide said end part into a plurality of valve members which are movable away from each other for passage of air;
an inlet hole formed in said upper flange surface and in fluid communication with said air intake tube; and
reinforcement ribs integral with said flange to extend toward and connect respectively to said valve members, each of said ribs forming an acute angle with a line along which said split extends.

7. The nipple as claimed in claim 6, wherein said lower flange surface has a recess that opens at said lower flange surface, said hollow air intake tube extending from said flange into said recess, said reinforcement ribs being integral with said flange and extending into said recess.

8. The nipple as claimed in claim 7, wherein said recess is confined by a side wall extending upwardly from said lower flange surface, and a top wall extending transversely of said side wall between said upper and lower flange surfaces, said side wall continuously looping around said recess, said hollow air intake tube projecting into said recess from said top wall without extending to a level lower than said lower flange surface.

9. The nipple as claimed in claim 6, wherein said split extends substantially in a diametral direction relative to an axis of said air intake tube, said acute angle being smaller than 45°.
